(19) United States
(12) Patent Application Publication
(10) Pub. No.: US 2011/0083139 A1
(43) Pub. Date: Apr. 7, 2011

(54) Disc chucking device and motor device having the same

(75) Inventors: Pyo Kim, Suwon (KR); Dong Yeon Shin, Suwon (KR)

(73) Assignee: SAMSUNG ELECTRO-MECHANICS CO., LTD., Suwon (KR)

(21) Appl. No.: 12/805,388

(22) Filed: Jul. 28, 2010

(30) Foreign Application Priority Data
Oct. 7, 2009 (KR) 10-2009-0095082

(51) Int. Cl. G11B 17/04

(52) U.S. Cl. 720/604; G9B/17.013

(57) ABSTRACT

There is provided a disc chucking device. A disc chucking device according to an aspect of the invention may include: a chuck housing having an opening communicating with a mounting space therein; a chuck member having one end portion exposed to an outside of the opening; and a spring member mounted within the mounting space in order to exert an elastic force to the chuck member, wherein a portion of an outer circumferential surface of the chuck housing, on which the chuck member is disposed, has a smaller outer diameter than other portions thereof.

### CROSS-REFERENCE TO RELATED APPLICATIONS

This application claims the priority of Korean Patent Application No. 10-2009-0095082 filed on Oct. 7, 2009, in the Korean Intellectual Property Office, the disclosure of which is incorporated herein by reference.

### BACKGROUND OF THE INVENTION

1. Field of the Invention

The present invention relates to a disc chucking device and a motor device having the same, and more particularly, to a disc chucking device that stably mounts a disc in a mounting position, and a motor device having the same.

2. Description of the Related Art

In general, a spindle motor, installed inside an optical disc drive, rotates a disc so that an optical pickup can read data recorded on the disc.

Small, lightweight, and thin hard disc drives are now required. In particular, as for an ultra-thin, slim motor, which is used in a laptop computer, a magnetic circuit for driving the motor is also reduced. Accordingly, various designs have been implemented to generate sufficient torque to rotate an optical disc and ensure the stable rotation thereof.

This motor device may separately include a disc chucking device in order to stably mount the disc thereupon.

Here, the disc chucking device, which is mounted within the motor device, includes a chuck housing that has an opening into which a chuck member for fixing the disc is assembled.

In general, the chuck housing is integrally prepared by injection molding. Since a portion of the chuck housing around the opening into which the chuck member is mounted needs to have a large thickness, an error in the figure may often occur, that is, an outer diameter of the chuck housing may not be manufactured according to precise figures.

Therefore, when the disc is inserted into the motor device, the disc is not properly inserted, since the outer diameter of the chuck housing is of greater diameter than a middle hole of the disc. This may cause a failure in equipment, and thus, the disc cannot function properly. Therefore, there is a need for techniques to solve these problems.

### SUMMARY OF THE INVENTION

An aspect of the present invention provides a disc chucking device that allows for the easy mounting of a disc, and a motor device having the same.

According to an aspect of the present invention, there is provided a disc chucking device including: a chuck housing having an opening communicating with amounting space therein; a chuck member having one end portion exposed to an outside of the opening; and a spring member mounted within the mounting space in order to exert an elastic force to the chuck member, wherein a portion of an outer circumferential surface of the chuck housing, on which the chuck member is disposed, has a smaller outer diameter than other portions thereof.

The chuck housing may include a guide portion protruding from an internal surface of the mounting space and guiding the mounting of the spring member.

The guide portion may have a multi-stage shape such that a front end thereof has a smaller width while a rear portion thereof has a larger width.

The guide portion may gradually decrease in width toward a front end.

The chuck housing may include a protrusion allowing an external disc to be mounted.

The chuck housing may include protrusions separated by a width of the spring member, and supporting an outside of the spring member.

According to another aspect of the present invention, there is provided a motor device including: a rotor case mounted rotatably about a shaft; a chuck housing mounted onto the rotor case and having an opening; a chuck member having one end portion exposed to an outside of the opening; and a spring member mounted within the opening to exert an elastic force to the chuck member, wherein a portion of an outer circumferential surface of the chuck housing, on which the chuck member is disposed, has a smaller outer diameter than other portions thereof.

The chuck housing may include a guide portion protruding from an inner surface of a mounting space and guiding a mounting operation of the spring member.

The guide portion has a multi-stage shape such that a front end thereof has a small width while a rear portion thereof has a large width.

The guide portion may gradually decrease in width toward a front end.

The chuck housing may include a protrusion allowing an external disc to be mounted.

The chuck housing may include protrusions protruding and separated by a width of the spring member, and supporting an outside of the spring member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a disc chucking device and a motor device according to an exemplary embodiment of the present invention;

FIG. 2 is a top view illustrating a disc chucking device according to an exemplary embodiment of the present invention;

FIG. 3 is a schematic sectional view illustrating the disc chucking device of FIG. 2;

FIGS. 4 and 5 are cross-sectional views illustrating a guide portion of a disc chucking device according to an exemplary embodiment of the present invention;

FIGS. 6 and 7 are cross-sectional views illustrating a guide portion of a disc chucking device according to another exemplary embodiment of the present invention; and

FIG. 8 is a rear view illustrating a disc chucking device to describe protrusions of a disc chucking device according to another exemplary embodiment of the present invention.

### DETAILED DESCRIPTION OF THE PREFERRED EMBODIMENT

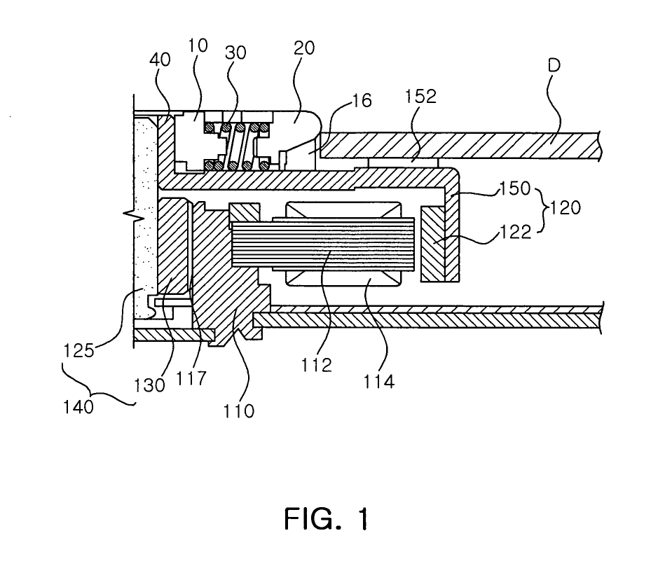

A disc chucking device and a motor device according to an exemplary embodiment of the invention will be described in detail with reference to FIGS. 1 through 7. Exemplary embodiments of the present invention will now be described in detail with reference to the accompanying drawings.

The invention may, however, be embodied in many different forms and should not be construed as being limited to the embodiments set forth herein. In the drawings, the shapes and dimensions may be exaggerated for clarity, and the same reference numerals will be used throughout to designate the same or like components.

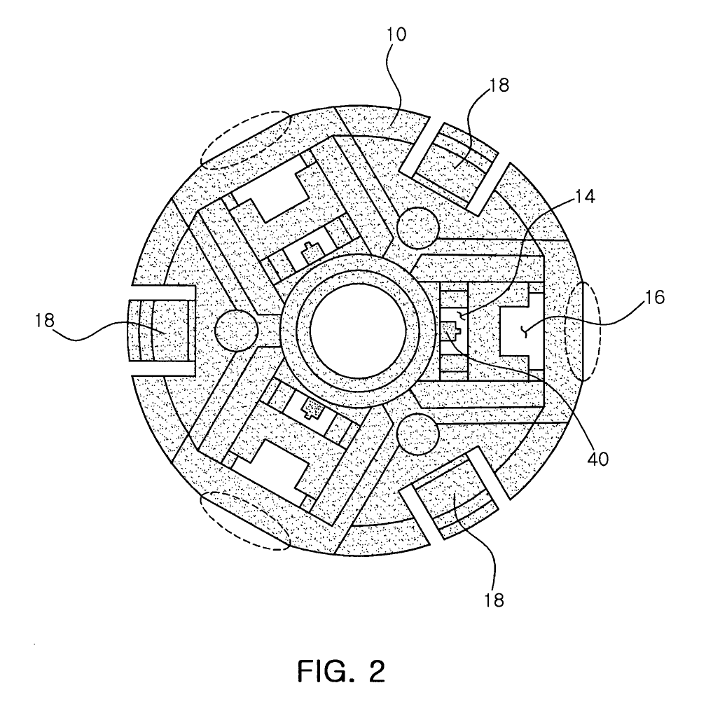

FIG. 1 is a cross-sectional view illustrating a disc chucking device and a motor device according to an exemplary embodiment of the invention. FIG. 2 is a top view illustrating the disc chucking device, shown in FIG. 1.

Referring to FIGS. 1 and 2, a disc chucking device may include a chuck housing 10, chuck members 20, and spring members 30.

The chuck housing 10 is mounted above a rotor case 150 and may have openings 12 each serving as a space within which the chuck member 20 is received while exposing the chuck chamber 20.

That is, the chuck members 20 may be mounted within the openings 12 such that the chuck members 20 are exposed to the outside. Spring members 30, which are coupled with the individual chuck members 20, may be inserted into the chuck members 20.

Furthermore, a check hole 14 may be formed through the outside of the chuck housing 10 in a position in which the spring member 30 is to be inserted in order to check whether the spring member 30 is inserted into the correct position or not.

Mounting portions 16 are formed in the individual openings 12 of the chuck housing 10 such that the mounting portions 16 protrude upwards. Here, each of the mounting portions 16 may be an inclined surface that ascends from the inside toward the outer circumference. Here, the mounting portions 16 may be formed integrally with the chuck housing 10.

The chuck housing 10 may include protrusions 18 that allow for the mounting of the disc D. The protrusions 18 may be formed integrally with the chuck housing 10, and there may be three protrusions 18 that form a 120 degree angle between each other.

Furthermore, the protrusions 18 may protrude outwardly by a predetermined distance from the chuck housing 10 and move into the chuck housing 10 when the disc D is inserted therein. Therefore, in order to implement this configuration, both sides of each of the protrusions 18 are cut off, so that only one side of each of the protrusions 18 is secured to the chuck housing 10.

The spring member 30 is disposed inside the opening 12, and applies an elastic force to the chuck member 20 when the chuck member 20 moves inwards.

Furthermore, the spring member 30 may include a coil spring. However, the invention is not limited thereto. Alternatively, the spring member 30 may include a plate spring.

Referring to FIG. 2, portions (marked with a dotted line) of the outer circumferential surface of the chuck housing 10, where the chuck members 20 are disposed, have a smaller outer diameter than other portions of the chuck housing 10.

Specifically, as shown in FIG. 2, the portions of the outer circumferential surface of the chuck housing 10 are curved inwards. Furthermore, the inwardly curved portions of the outer circumferential surface thereof may be arranged at approximately 120 degree angles at positions corresponding to those in which the chuck members 20 are mounted.

FIG. 3 is a schematic sectional view illustrating the effects of the disc chucking device, shown in FIG. 2.

As shown in FIG. 3, the mounting portions 16 may have the same outer diameter as the outer circumferential surface of the chuck housing 10 or may have slightly larger outer diameters than the outer circumferential surface thereof as marked with a dotted line.

Therefore, when the disc D is inserted, since the outer diameter of the chuck housing 10 is greater than that of the middle hole of the disc D due to an error in the figure, the disc D may not be properly inserted.

However, when the portions of the chuck housing 10, where the chuck members 20 are disposed, are formed to have a smaller outer diameter than other portions thereof, it is possible to insert the disc D despite an error in the figure. Therefore, the stable driving of the disc D is realized.

The components, described in FIG. 1, will now be described in detail.

With reference to FIG. 1, the motor device may include the chuck housing 10, the chuck members 20, the spring members 30, a stator 110, a rotor 120, a bearing assembly 140, and a rotor case 150.

Here, the chuck housing 10, the chuck members 20, and the spring members 30 have been described above.

The stator 110 is a stationary structure that includes winding coils 114 generating an electromagnetic force when power is applied, and a plurality of cores 112 around which the winding coils 114 are wound radially on the basis of at least one pole.

The rotor 120 is a rotary structure that is rotatable with respect to the stator 110. A cup-shaped rotor case 10 has an annular magnet 122 along an outer circumferential surface thereof. Here, the annular magnet 122 corresponds to the cores 112 at predetermined distances therebetween. The magnet 122 includes a permanent magnet having magnetic north and south poles magnetized alternately in the circumferential direction to generate a magnetic force having a predetermined magnitude.

The bearing assembly 140 may include a shaft 125 that coincides with a rotary center of the rotor 120 and a sleeve 130 having a shaft groove in which the shaft 125 is arranged.

The sleeve 130 is a rotation support member that corresponds to the rotor 120 at a predetermined interval to form a sliding surface therebetween. Here, a lower end of a body of the sleeve 130 may be pressed and inserted into amounting hole 117 of the stator 110.

The rotor case 150 is rotatably mounted with respect to the shaft 125, and may be rotated by the rotation of the shaft 125 inside the sleeve 130.

The rotor case 150 may have the shape of a disc. The magnet 122 may be mounted inside the rotor case 150 so that the magnet 122 faces the winding coil 114.

Here, an area where the rotor case 150 and the shaft 125 come into contact with each other is formed in a lengthwise direction. That is, a contact surface between the rotor case 150 and the shaft 125 extends in the lengthwise direction, thereby increasing drawing force.

Furthermore, the disc D is mounted on the upper surface of the rotor case 150. A damper 152, formed of rubber materials, may be formed so that the damper 152 makes contact with the lower surface of the disc D.

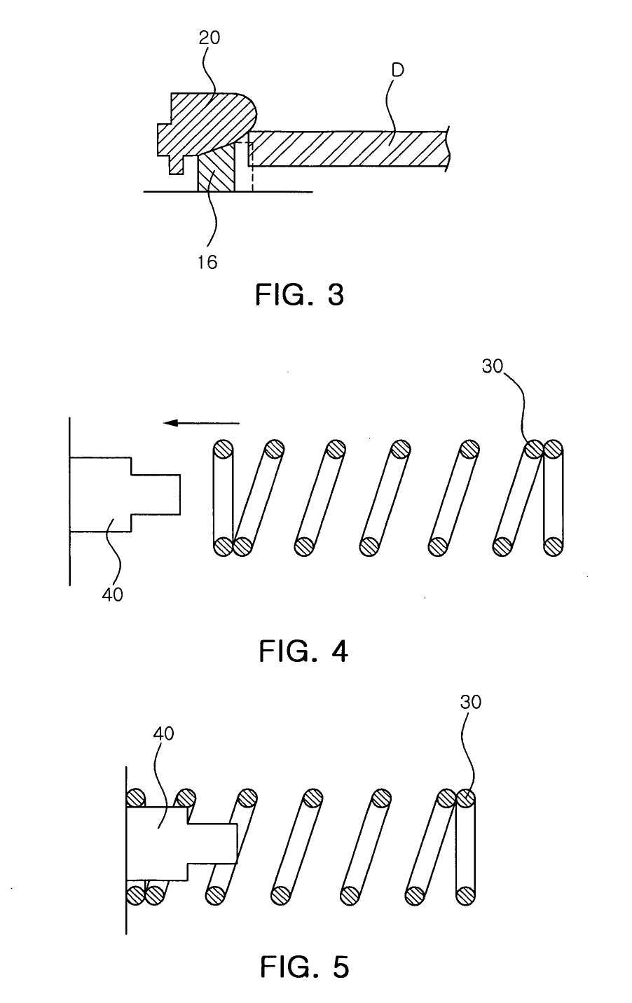

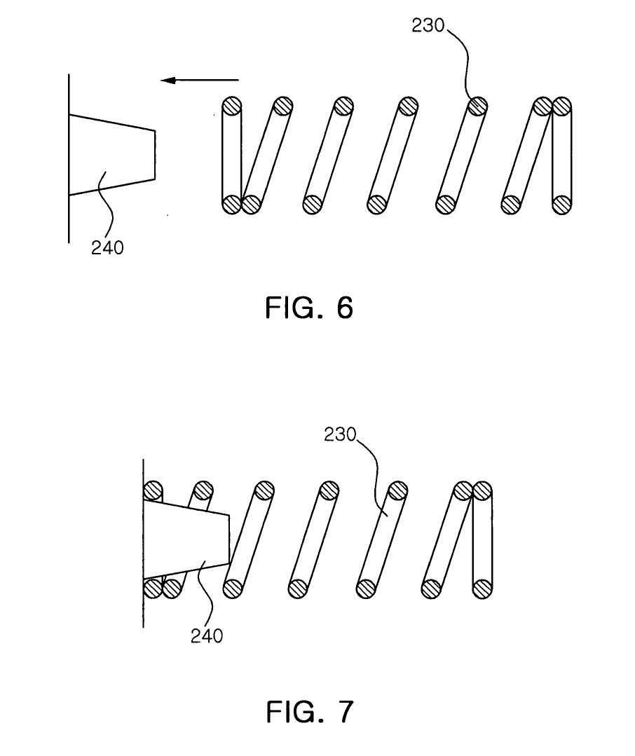

FIGS. 4 and 5 are cross-sectional views illustrating a guide portion of a disc chucking device according to an exemplary embodiment of the invention.

Referring to FIGS. 4 and 5, the chuck housing 10 may include guide portions 40 that guide the spring members 30 so as to be mounted within the respective openings 12.

Therefore, since the spring members 30 are inserted into the guide portions 40, the spring members 30 may be secured at the position (in the direction of the arrow of FIG. 4).

Each of the guide portions 40 has a multi-stage shape such that a front end thereof is small and a rear portion thereof has a large width. Therefore, when the spring member 30 is inserted through the guide portion 40, since the front end of the guide portion 40 is small, it is possible to prevent the incorrect insertion of the spring member 30.

Therefore, when the spring member 30 is inserted into the guide portion 40, the spring member 30 is caught by the front end of the guide portion 40, thereby preventing assembly failure.

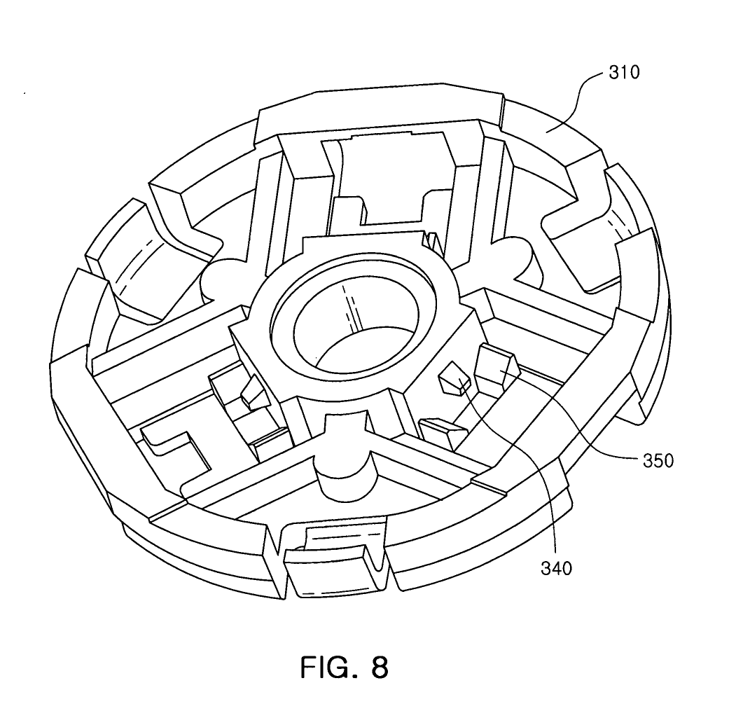

FIGS. 6 and 7 are cross-sectional views illustrating a guide portion of a disc chucking device according to another exemplary embodiment of the invention.

Referring to FIGS. 6 and 7, a chuck housing may include a guide portion 240 in order to guide a spring member 230 such that the spring member 230 is mounted within an opening.

Therefore, the spring member 230 may be inserted into the guide portion 240 and be fixed in that position (in the direction of the arrow of FIG. 6).

The guide portion 240 decreases in width toward the end. The guide portion 240 may have an inclined cross-section, and is formed into a trapezoidal shape.

Therefore, when the spring member 230 is inserted into the guide portion 240, since the guide portion 240 has a small front end, thereby preventing the incorrect insertion of the spring member 230.

Therefore, when the spring member 230 is inserted into the guide portion 240, the spring member 230 is caught by the front end of the guide portion 240.

FIG. 8 is a rear view illustrating protrusions of a disc chucking device according to another exemplary embodiment of the invention.

Referring to FIG. 8, a chuck housing 310 may include guide portions 340 in order to guide spring members so that the respective spring members are mounted within openings.

Furthermore, the chuck housing 310 may include protrusions 350 that protrude and are separated by the width of the spring member, and support the outside of the spring member.

Here, there may be provided two protrusions 350 in order to support both sides of the spring member. However, the invention is not limited thereto. One protrusion or three or more protrusions may be formed according to the designers' intentions.

Furthermore, the protrusion 350 has one surface having a tapered shape corresponding to a round shape of the spring member. Alternatively, the one surface of the protrusion 350 may have a curved surface having the same curvature as the outside of the spring member rather than the tapered shape.

Therefore, in this embodiment, since the protrusions 350 support the outside of the spring member, the position at which the spring member is mounted inside the chuck housing 310 is not changed, so that the spring member can stably elastically support the chuck member.

As set forth above, according to exemplary embodiments of the invention, since portions of an outer circumferential surface of a chuck housing, where chuck members are disposed, have a smaller outer diameter than other portions thereof, an error in the figure that occurs in the portions can be prevented, thereby preventing the incorrect insertion of a disc.

Furthermore, in a disc chucking device and a motor device according to an exemplary embodiment of the invention, since a front end of a guide portion guiding the mounting of a spring member is narrower than the other part of the guide portion, the spring member is caught by the front end of the guide portion when inserting the spring member, thereby preventing assembly failure.

While the present invention has been shown and described in connection with the exemplary embodiments, it will be apparent to those skilled in the art that modifications and variations can be made without departing from the spirit and scope of the invention as defined by the appended claims.

What is claimed is:

1. A disc chucking device comprising:
a chuck housing having an opening communicating with a mounting space therein;
a chuck member having one end portion exposed to an outside of the opening; and
a spring member mounted within the mounting space in order to exert an elastic force to the chuck member,
wherein a portion of an outer circumferential surface of the chuck housing, on which the chuck member is disposed, has a smaller outer diameter than other portions thereof.

2. The disc chucking device of claim 1, wherein the chuck housing comprises a guide portion protruding from an internal surface of the mounting space and guiding the mounting of the spring member.

3. The disc chucking device of claim 2, wherein the guide portion has a multi-stage shape such that a front end thereof has a smaller width while a rear portion thereof has a larger width.

4. The disc chucking device of claim 2, wherein the guide portion gradually decreases in width toward a front end.

5. The disc chucking device of claim 1, wherein the chuck housing comprises a protrusion allowing an external disc to be mounted.

6. The disc chucking device of claim 1, wherein the chuck housing comprises protrusions separated by a width of the spring member, and supporting an outside of the spring member.

7. A motor device comprising:
a rotor case mounted rotatably about a shaft;
a chuck housing mounted onto the rotor case and having an opening;
a chuck member having one end portion exposed to an outside of the opening; and
a spring member mounted within the opening to exert an elastic force to the chuck member,
wherein a portion of an outer circumferential surface of the chuck housing, on which the chuck member is disposed, has a smaller outer diameter than other portions thereof.

8. The motor device of claim 7, wherein the chuck housing comprises a guide portion protruding from an inner surface of a mounting space and guiding a mounting operation of the spring member.

9. The motor device of claim 8, wherein the guide portion has a multi-stage shape such that a front end thereof has a small width while a rear portion thereof has a large width.

10. The motor device of claim 8, wherein the guide portion gradually decreases in width toward a front end.

11. The motor device of claim 7, wherein the chuck housing comprises a protrusion allowing an external disc to be mounted.

12. The motor device of claim 7, wherein the chuck housing comprises protrusions protruding and separated by a width of the spring member, and supporting an outside of the spring member.
